(19) United States
(12) Patent Application Publication
(10) Pub. No.: US 2008/0094381 A1
(43) Pub. Date: Apr. 24, 2008

(54) Semiconductor integrated circuit device

(75) Inventor: Hitoshi Hiratsuka, Shiga (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kanagawa (JP)

(21) Appl. No.: 11/907,896

(22) Filed: Oct. 18, 2007

(30) Foreign Application Priority Data
Oct. 19, 2006 (JP) 2006-285282

(51) Int. Cl. G09G 5/00

(52) U.S. Cl. 345/205

(57) ABSTRACT

In a case where the data drive circuit is used for a face-up mounting, a reverse switching circuit is controlled so that a reverse switching signal RB can be at an “H” level. Thus, an output terminal S1₁ is caused to function as an output terminal from which to output a drive signal representing the R color, whereas an output terminal S1₃ is caused to function as an output terminal from which to output a drive signal representing the B color. In a case where the data drive circuit is used for a face-down mounting, the reverse switching circuit is controlled so that the reverse switching signal RB can be at an “L” level. Thus, the output terminal S1₁ is caused to function as the from which to output the drive signal representing the B color, whereas the output terminal S1₃ is caused to function as the output terminal from which to output the drive signal representing the R color.

### BACKGROUND OF THE INVENTION

1. Field of the Invention

The present invention relates to a semiconductor integrated circuit device, and particularly to a semiconductor integrated circuit device which is able to be mounted not only face up but also face down on a substrate.

2. Description of Related Art

Color displays such as Liquid crystal display devices and organic EL (Electroluminescent) display devices have been commercialized as dot matrix display device. The dot matrix display device includes a display panel and data drive circuits. The display panel has multiple pixels arranged in matrix. Each pixel is configured of three dot-pixels each for red, (hereinafter referred to as “R”), green (hereinafter referred to as “G”) blue (hereinafter referred to “B”), which are arranged in accordance with a predetermined rule. Each dot-pixel is driven by a corresponding one of the data drive circuits. Some types of dot matrix display device are designed to cause each of drive signals from the data drive circuits to have a γ-curve characteristic for each of the R, G and B colors, which are going to be represented by the corresponding dot-pixels. In general, each of the data drive circuits is configured of a semiconductor integrated circuit device (hereinafter referred to an “IC”).

FIG. 10 is a block diagram showing a configuration of an organic EL display device as the display device shown in Japanese Patent Application Laid-open Publication No. 2000-231358.

FIG. 11 is a block diagram showing a configuration of a data drive circuit 12 used in the organic EL display device shown in FIG. 10. As shown in FIG. 10, the organic EL display device includes: a display panel 1 capable of performing color display; and a drive unit for driving this display panel 1.

The display panel 1 includes: multiple pixels each configured of multiple organic EL elements which are arranged in matrix; multiple scan electrodes 2 each for sequentially selecting lines for performing display; and multiple data electrodes 3 each for driving pixels on a selected line on a basis of data on display. In the display panel 1, pixels each for the R, G B color are arranged in accordance with a predetermined rule. Each of the data electrodes 3 includes: an electrode 3R for the R color; an electrode 3G for the G color; and an electrode 3B for the B color. Electrodes 3R, electrodes 3G and electrodes 3B are arranged corresponding to the arrangement of the pixels in accordance with a predetermined rule. In this case, the electrodes 3R, 3G and 3B are arranged in a repeated sequence in a way that one electrode 3R is followed by one electrode 3Q followed by one electrode 3B.

The drive unit includes data drive circuits 12 each for driving the data electrodes 3 in the display panel 1 on a basis of data on display. The multiple drive circuits 12 are integrated, and thus included, in the drive unit. The drive circuits 12 are connected to one after another in a cascade arrangement.

As shown in FIG. 11, each of the data drive circuits 12 includes PWM output units 23R, 23G and 23B, as well as output stage driver 25R, 25G and 25B, for discretely controlling output signals for each of the R, G and B colors. An output unit 26 in each of the data drive circuits 12 includes multiple output terminal groups 27 each consisting of three output terminals 27R, 27G and 27B each for outputting output signals on a one-by-one basis from a corresponding one of the output stage drivers 25R, 25G and 25B. Thereby, the discretely controlled drive signals each for a corresponding one of the R, G and B colors can be outputted, as a set, to the display panel 1.

FIG. 12 schematically shows how wirings are connected to the data drive circuits 12 and to the display panel 1. As shown in FIG. 12, the sequence in which the output terminals in each of the data drive circuits 12 are arranged is designed to be the same as the sequence in which the data electrodes 3R, 3G and 3B serving as input terminals of the display panel 1 are arranged, the input terminals corresponding respectively to the output terminals. It should be noted that reference numerals “01,” “02,” . . . , “m,” “m+1,” “m+2,” . . . and “n” in FIG. 12 denote the column number. Specific operations of the data drive circuits 12 have been described in Patent Document 1 in detail, and the detailed description for the specific operations will be omitted here.

In a case where, however, the integrated data drive circuits 12 are intended to be mounted on a predetermined substrate, a problem with the mounting is that it is impossible to dually use IC chips of a single type for the face-up mounting and the face-down mounting. Descriptions will be provided for the problem with reference to the drawings.

FIG. 13 shows a specific example of a case where the output terminals 27R, 27G and 27B of each of the data drive circuits 12 are connected to the corresponding data electrodes 3R, 3G and 3B in the display panel 1 with the data drive circuit 12 mounted face up. In this example, the output terminal 27R and the data electrode 3R are connected to each other, the output terminal 27G and the data electrode 3G are connected to each other, and the output terminal 27B and the data electrode 3B are connected to each other, with the front surface of an IC chip constituting each of the data drive circuits 12 pointing upwards.

By contrast, FIG. 14 shows relationships in which the output terminals 27R, 27G and 27B of each of the data drive circuits 12 are connected to the corresponding data electrodes 3R, 3G and 3B in the display panel 1 in a case where chips of the same type as are used in the example shown in FIG. 13 are intended to be used as the data drive circuits 12 with the chips mounted face down. As shown in FIG. 14, in the case where chips of the same type as are used in the example shown in FIG. 13 are intended to be mounted thereon with the front surfaces of the respective chips pointing downward, the output terminals 27R and the corresponding data electrodes 3B are connected to each other, the output terminals 27G and the corresponding data electrodes 3G are connected to each other, and the output terminals 27B and the corresponding data electrodes 3R are connected to each other. The data electrodes 3R are not connected to the output terminals 27R, and the data electrodes 3B are not connected to the output terminals 27B. As a result, a drive signal with the γ-curve characteristic corresponding to the R color is outputted from each of the output terminals 27R to the corresponding one of the data electrodes 3B, whereas a drive signal with the γ-curve characteristic corresponding to the B color is outputted from each of the output terminals 27B to the corresponding one of the data electrodes 3R.

For this reason, in the case where the data drive circuits 12 are intended to be mounted face down on the display panel 1, chips obtained by replacing the output terminals 27R and 27B with each other in chips of the same type as are mounted face up need to be prepared as the chips to be mounted face down in order that the data electrodes 3R can be connected to the corresponding output terminals 27R whereas the data electrodes 3B can be connected to the corresponding output terminals 27B (the output terminals 27G are replaced with neither the output terminals 27R nor the output terminals 27B). In other words, IC chips for the data drive circuits to be mounted face up and IC chips for the data drive circuits to be mounted face down need to be prepared separately. This brings about a problem that IC chips of a single type which are designed for data drive circuits cannot be used both a substrate to which a mounting method (a face-up method) is applied and a substrate to which the other mounting method (a face-down method) is applied.

### SUMMARY

A semiconductor integrated circuit device according to the present invention includes: a dual-use terminal capable of functioning as both a terminal which is used when the semiconductor integrated circuit device is mounted face up and a terminal which is used when the semiconductor integrated circuit device is mounted face down; and a switching circuit for switching the functions of the dual-use terminal in order that the dual-use terminal can function as the terminal for the face-up mounting or the terminal for the face-down terminal.

In the case of the present invention, the semiconductor integrated circuit device is provided with the switching circuit in order that the dual-use terminal of an IC can function as the terminal for the face-up mounting when the IC is mounted face up on a substrate, and that the dual-use terminal of the IC can function as the terminal for the face-down mounting when the IC is mounted face down on the substrate. The present invention makes it possible for IC chips of a single type to be dually used for the face-up mounting and the face-down mounting. This makes it unnecessary that IC for the face-up mounting and the IC for the face-down mounting should be prepared separately.

### BRIEF DESCRIPTION OF THE DRAWINGS

The above and other aspects, advantages and features of the present invention will be more apparent from the following description of certain preferred embodiments taken in conjunction with the accompanying drawings, in which:

FIG. 1 is a block diagram showing a configuration of a liquid crystal display device according to the present invention;

FIG. 2 is a block diagram of a data drive circuit according to an embodiment of the present invention;

FIG. 3 is a block diagram of a D/A converter and an output circuit in the data drive circuit shown in FIG. 2;

FIG. 4 is a diagram for explaining how the output circuit operates in a case where the data drive circuit shown in FIG. 2 is used for a face-up mounting;

FIG. 5 is a diagram for explaining a relationship in which data drive circuits of a type shown in FIG. 2 are connected to a display panel in the case where the data drive circuits are used for the face-up mounting;

FIG. 6 is a diagram for explaining how the output circuit operates when a POL is at an “H” level in the case where the data drive circuit shown in FIG. 2 is used for the face-up mounting;

FIG. 7 is a diagram for explaining how the output circuit operates when the POL is at an “L” level in the case where the data drive circuit shown in FIG. 2 is used for the face-up mounting;

FIG. 8 is a diagram for explaining how the output circuit operates when the data drive circuit shown in FIG. 2 is used for a face-down mounting;

FIG. 9 is a diagram for explaining a relationship in which the data drive circuits of the type shown in FIG. 2 are connected to the display panel in the case where the data drive circuits are used for the face-down mounting;

FIG. 10 is a block diagram showing a configuration of an organic EL display device of a related art;

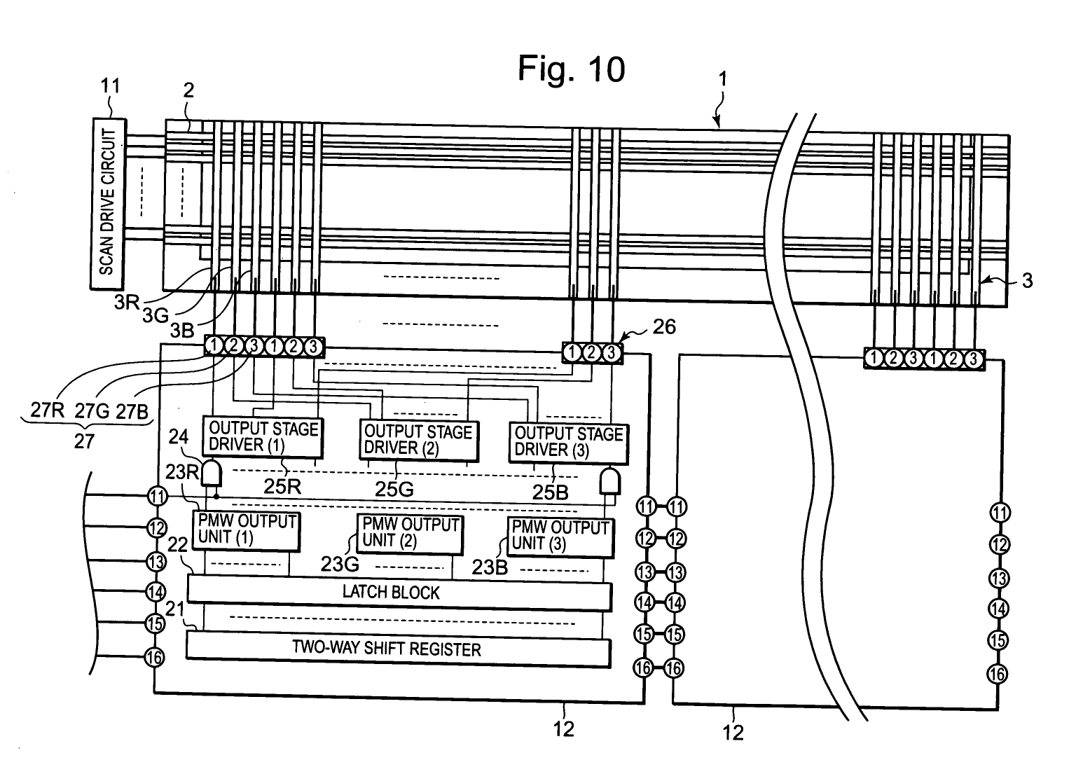

FIG. 11 is a block diagram showing a configuration of a data drive circuit of a conventional type which is used for the organic EL display device shown in FIG. 10;

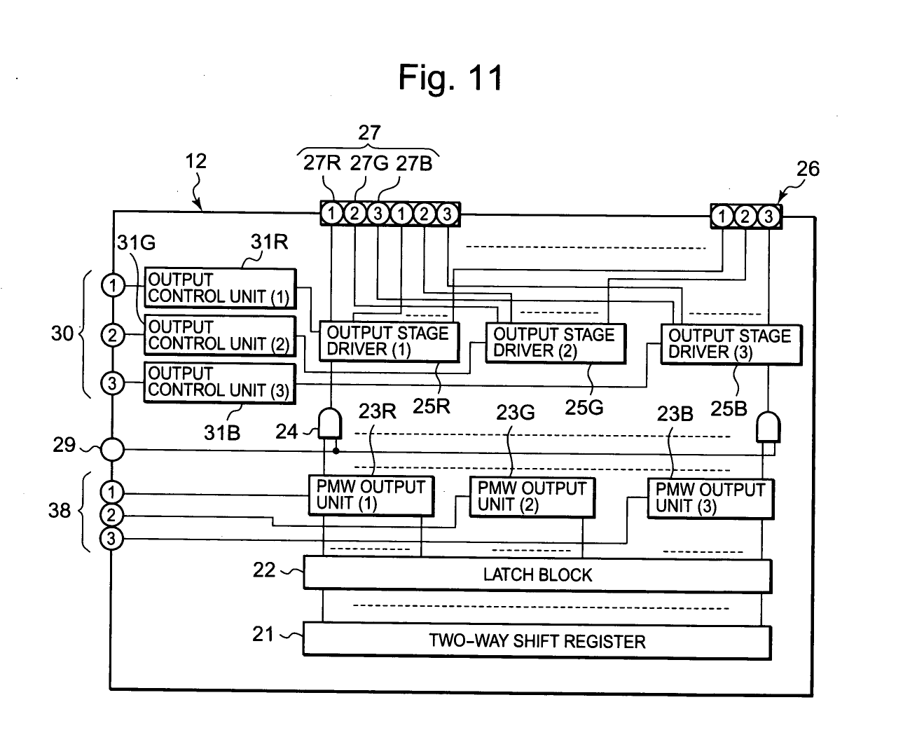

FIG. 12 is an explanatory diagram conceptually showing how wirings connect data drive circuits shown in FIG. 11 to a display panel;

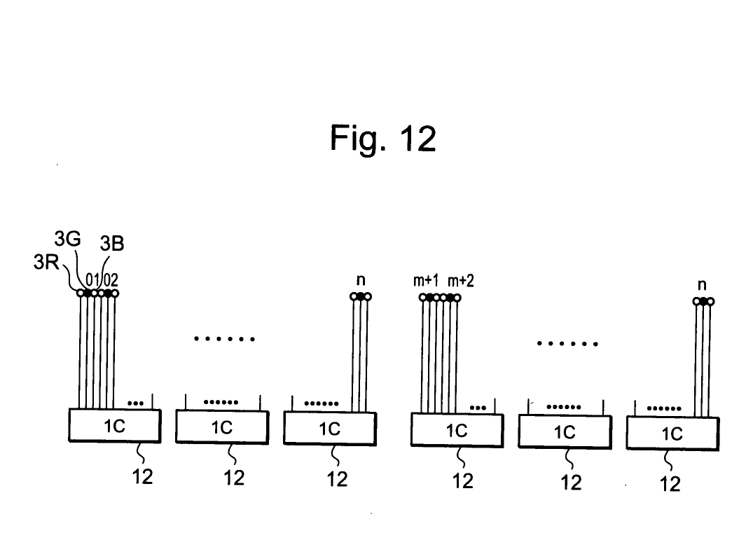

FIG. 13 is a diagram for explaining a relationship in which the data drive circuits shown in FIG. 11 are connected to the display panel in a case where the data drive circuits are used for the face-up mounting; and

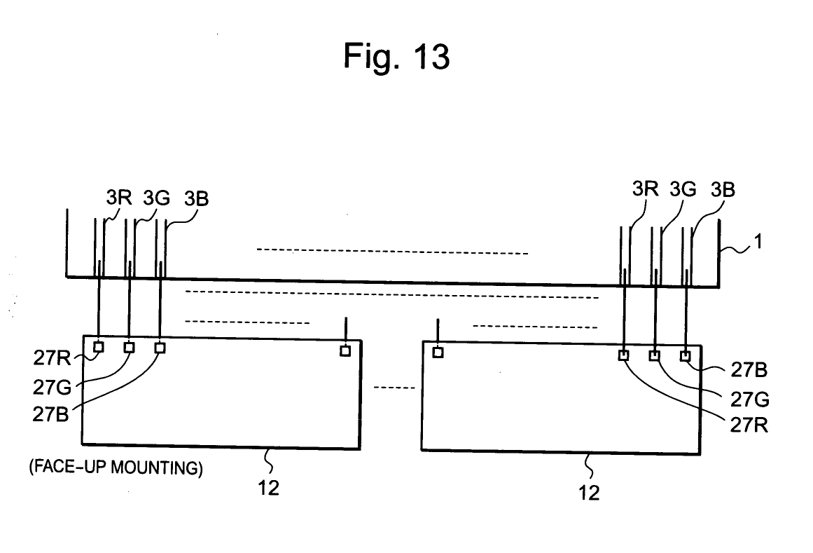

FIG. 14 is a diagram for explaining a relationship in which the data drive circuits shown in FIG. 11 are connected to the display panel in a case where the data drive circuits are intended to be used for the face-down mounting.

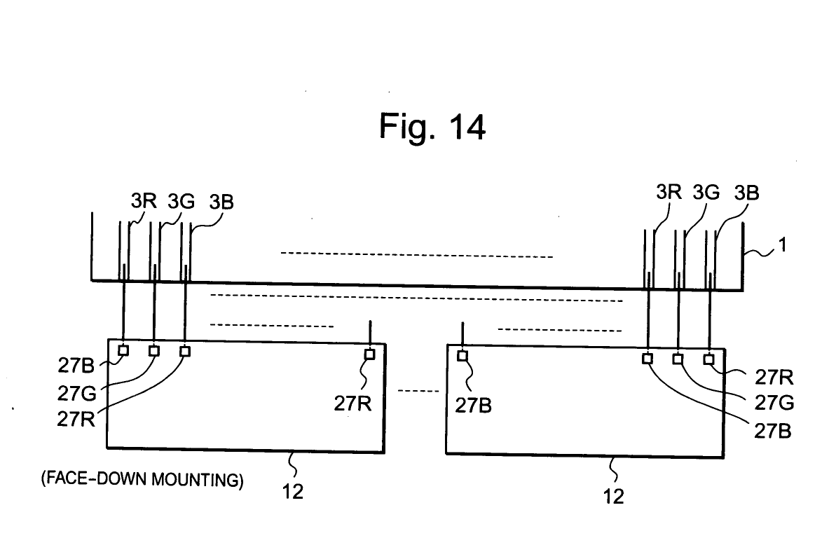

### DETAILED DESCRIPTION OF THE EXEMPLARY EMBODIMENT

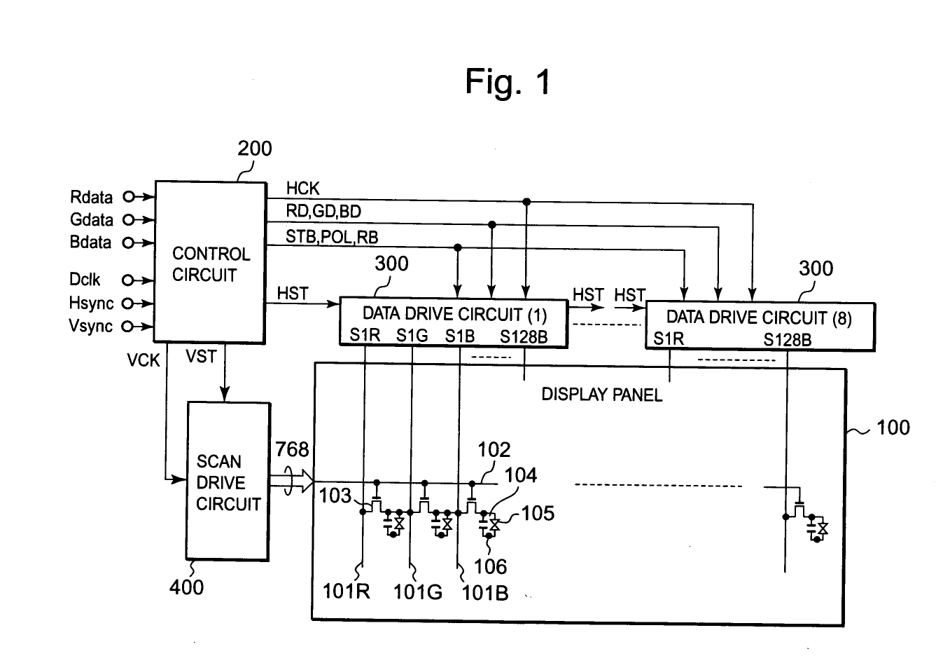

FIG. 1 is a block diagram showing a configuration of a liquid crystal display device as a display device according to the present invention. As shown in FIG. 1, the liquid crystal display device includes a display panel 100, a control circuit 200, data drive circuits 300, and a scan drive circuit 400. From now on, the specific embodiment will be described citing a case where the resolution of the display panel 100 is XGA (1024×768 pixels display resolution; each pixel consisting of three dot-pixels each representing the R, G B color) while the display panel 100 displays 262144 colors (64 gradations are set up for each of the R, G and B colors).

The display panel 100 includes: 1024 R data lines 101R, 1024 G data lines 101G and 1024 B data lines 101B which are arranged side-by-side in the horizontal direction in FIG. 1, and which extend in the vertical direction in FIG. 1; and 768 scan lines 102 which are arranged side-by-side in the vertical direction in FIG. 1, and which extend in the vertical direction in FIG. 1 (only one scan line is illustrated in FIG. 1). Each dot-pixel is configured of a TFT 103, a pixel capacitance 104 and a liquid crystal element 105. The gate terminal of the TFT 103 is connected to one of the scan lines 102. The source (drain) terminal of the TFT 103 is connected to one of the data lines 101R, 101G and 101B. In addition, a pixel capacitance 104 and a liquid crystal element 105 are connected to the drain (source) terminal of the TFT 103. A terminal 106 of the pixel capacitance 104 and the liquid crystal element 105, which is not connected to the TFT 103, is connected, for example, to a common electrode, which is not illustrated.

The control circuit 200 converts digital image data which has been supplied from the outside to digital gradation data with which the data drive circuit 300 is capable of driving (hereinafter referred to “data”), and concurrently controls timings of the data drive circuits 300 and the scan drive circuit 400.

For each of the scan lines 102 (for each horizontal period), each of the data drive circuits 300 converts data, represented by the scan line 102 which has been supplied from the control circuit 200, to analog drive signals, and thus outputs the analog drive signals to the data lines 101R, 101G and 101B. The data drive circuits 300 are integrated. In the example shown in FIG. 1, 8 data drive circuits 300 are provided to the liquid crystal display device, and are connected to one after another in a cascade arrangement.

For each horizontal period, the scan drive circuit 400 sequentially drives the scan lines 102, and thus performs an ON control on TFTs arrayed in each of the sequentially driven scan lines 102, hence supplying the liquid crystal elements 105 with the their drive signals to be applied to the corresponding data lines 101R, 101G and 101B.

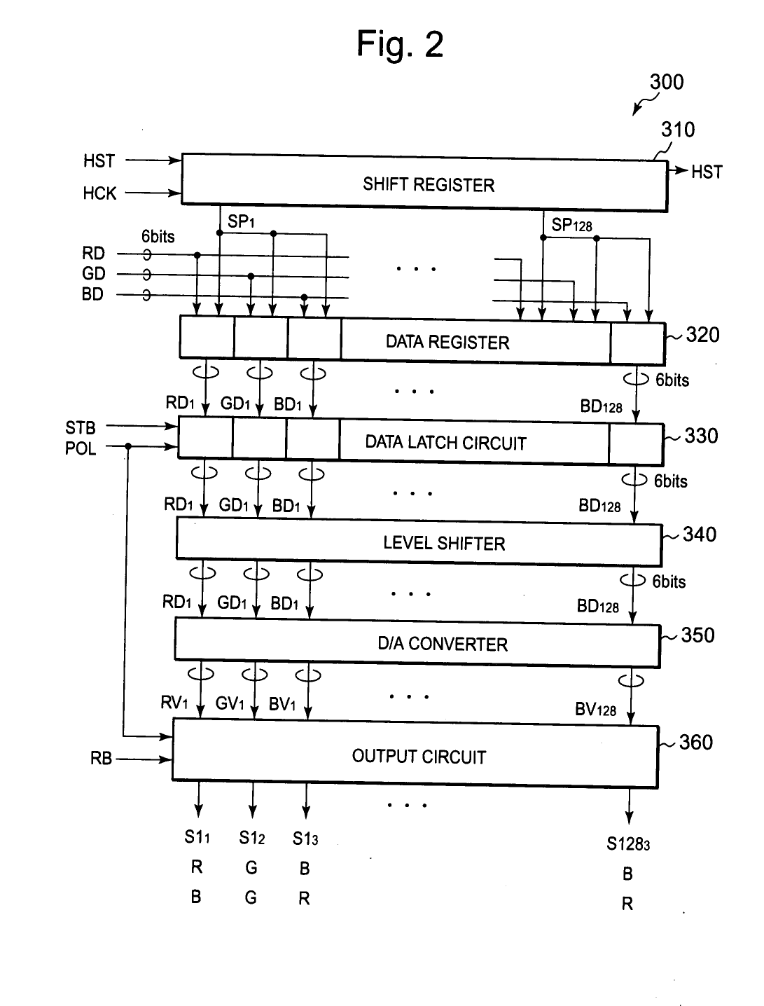

FIG. 2 is a block diagram showing a configuration of one of the data drive circuits 300 according to the embodiment of the present invention, which is applied to the liquid crystal display device. In the example shown in FIG. 2, one data drive circuits 300 is in charge of performing display on 128 pixels (128 pixels×3 dots per pixel=384 outputs). As shown in FIG. 2, the data drive circuit 300 includes a shift register 310, a data register 320, a data latch circuit 330, a level shifter 340, a D/A converter 350, and an output circuit 360. In the case of the foregoing liquid crystal display device, outputs from the shift registers 310 of one of the data drive circuits 300 are outputted to the shift register 310 of the following one of the data drive circuits 300 in the cascade arrangement. The 8 data drive circuits 300 are connected to one after another in the cascade arrangement.

The shift register 310 are configured of 128 registers. A start pulse HST and a clock HCK are supplied to the shift register 310. The shift register 310 shifts the start pulse HST sequentially at the timing of the clock HCK, and thus outputs the resultant shift pulses SP1 to SP128 to the data register 320. Concurrently, the shift register 310 outputs a start pulse HST for connecting the following one of the data drive circuits 300 to the current one thereof in the cascade arrangement.

The data register 320 is configured of 128 registers. 6-bit parallel data RD on the R color, 6-bit parallel data GD on the G color and 6-bit parallel data BD on the B color are supplied to each register. For instance, at fall timings respectively of the shift pulses SP1 to SP128 supplied from the shift register 310, the registers sequentially hold corresponding sets of data RD₁, data GD₁ and data BD₁ to data RD₁₂₈, data GD₁₂₈ and data BD₁₂₈.

The data latch circuit 330 is supplied with a strobe signal STB once the sets of data RD₁, data GD₁ and data BD₁ to data RD₁₂₈, data GD₁₂₈ and data BD₁₂₈ have been inputted respectively to all of the registers of the data register 320. Thereby, the data latch circuit 330 latches all the sets of data RD₁, data GD₁ and data BD₁ to data RD₁₂₈, data GD₁₂₈ and data BD₁₂₈ which have been held respectively in the registers of the data register 320. Subsequently, the sets of data RD₁, data GD₁ and data BD₁ to data RD₁₂₈, data GD₁₂₈ and data BD₁₂₈ which have been latched by the data latch circuit 330 are shifted in level by the level shifter 340 depending on the necessity.

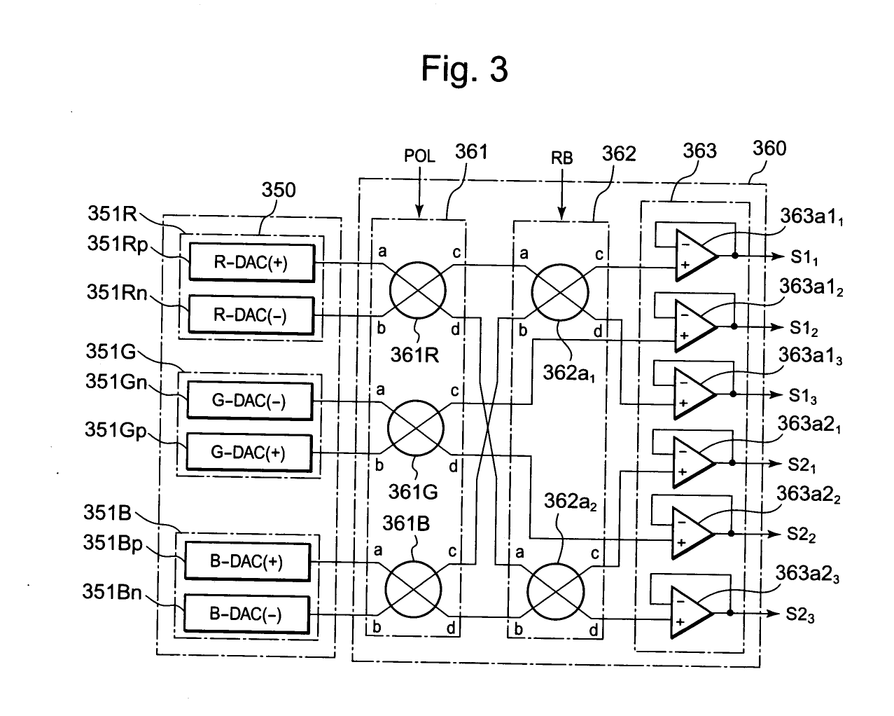

The D/A converter 350 decodes the level-shifted sets of data RD₁, data GD₁ and data BD₁ to data RD₁₂₈, data GD₁₂₈ and data BD₁₂₈, and thus outputs sets of drive signals RV1, GV1 and BV1 to drive signals RV₁₂₈, GV₁₂₈ and BV₁₂₈. FIG. 3 shows a case where 6 outputs are outputted from the D/A converter 350. As shown in FIG. 3, the D/A converter 350 includes: a D/A converter 351R for outputting a drive signal for the R color; a D/A converter 351G for outputting a drive signal for the G color; and a D/A converter 351B for outputting a drive signal for the B color. In addition, the D/A converters 351R, 351G and 351B include D/A converters 351Rp, 351Gp and 351Bp each for outputting a positive drive signal; and D/A converters 351Rn, 351Gn and 351Bn each for outputting a negative drive signal. The D/A converter 351R, 351G and 351B output their drive signals each with the γ-curve characteristic for the R, G and B colors, respectively.

The output circuit 360 amplifies the drive signals RV₁, GV₁ and BV₁ to RV₁₂₈, GV₁₂₈ and BV₁₂₈ supplied from the D/A converter 350, and thus supplies the amplified drive signals RV₁, GV₁ and BV₁ to RV₁₂₈, GV₁₂₈ and BV₁₂₈ respectively to output terminals S1₁, S1₂ and S1₃ to S128₁, S128₂ and S128₃. As illustrated in FIG. 3 which shows the case where the 6 outputs are outputted from the D/A converter 350, the output circuit 360 includes a polarity switching circuit 361, an a Reverse (RB) switching circuit 362 and an output amplifying circuit 363.

The polarity switching circuit 361 includes three switching switches 361R, 361G and 361B which are controlled by a polarity switching signal POL. In each of the switching switches 361R, 361G and 361B, the input terminal a is connected to the output terminal c whereas the input terminal b is connected to the output terminal d, when the polarity switching signal POL is at the “H” level. The input terminal a is connected to the output terminal d whereas the input terminal b is connected to the output terminal c, when the polarity switching signal POL is at the “L” level. In the switching switch 361R, the output of the D/A converter 351Rp is connected to the input terminal a, and the output of the D/A converter 351Rn is connected to the input terminal b. Similarly, in the switching switch 361G, the output of the D/A converter 351Gn is connected to the input terminal a, whereas the output of the D/A converter 351Gp is connected to the input terminal b. In the switching switch 361B, the output of the D/A converter 351Bp is connected to the input terminal a, whereas the output of the D/A converter 351Bn is connected to the input terminal b.

The reverse switching circuit 362 includes two switching switch 362a₁ and 362a₂ which are controlled by the Reverse switching signal RB. In each of the switching switches 362a₁ and 362a₂, the input terminal a is connected to the output terminal c whereas the input terminal b is connected to the output terminal d, when the reverse switching signal RB is at the “H” level. The input terminal a is connected to the output terminal d whereas the input terminal b is connected to the output terminal c, when the reverse switching signal RB is at the “L” level. In the switching switch 362a₁, the output terminal c of the switching switch 361R is connected to the input terminal a, whereas the output terminal c of the switching switch 361B is connected to the input terminal b. In the switching switch 362a₂, the output terminal d of the switching switch 361R is connected to the input terminal a, whereas the output terminal d of the switching switch 361B is connected to the input terminal b.

The output amplifying circuit 363 includes 6 AMPs 363a1₁, 363a1₂, 363a1₃, 363a2₁, 363a2₂ and 363a2₃, each in the voltage-follower connection, for amplifying and outputting the drive signals each with a polarity corresponding to the polarity switching signal POL, the drive signals being outputted from the D/A converter 350. The output terminal c of the switching switch 362a₁ is connected to the noninverting input terminal (+) of the AMP 363a1₁. The output terminal c of the switching switch 361G is connected to the noninverting input terminal (+) of the AMP 363a1₂. The output terminal d of the switching switch 362a₁ is connected to the noninverting input terminal (+) of the AMP 363a1₃. The output terminal c of the switching switch 362a₂ is connected to the noninverting input terminal (+) of the AMP 363a2₁. The output terminal d of the switching switch 361G is connected to the noninverting input terminal (+) of the AMP 363a2₂. The output terminal d of the switching switch 362a₂ is connected to the noninverting input terminal (+) of the AMP 363a2₃.

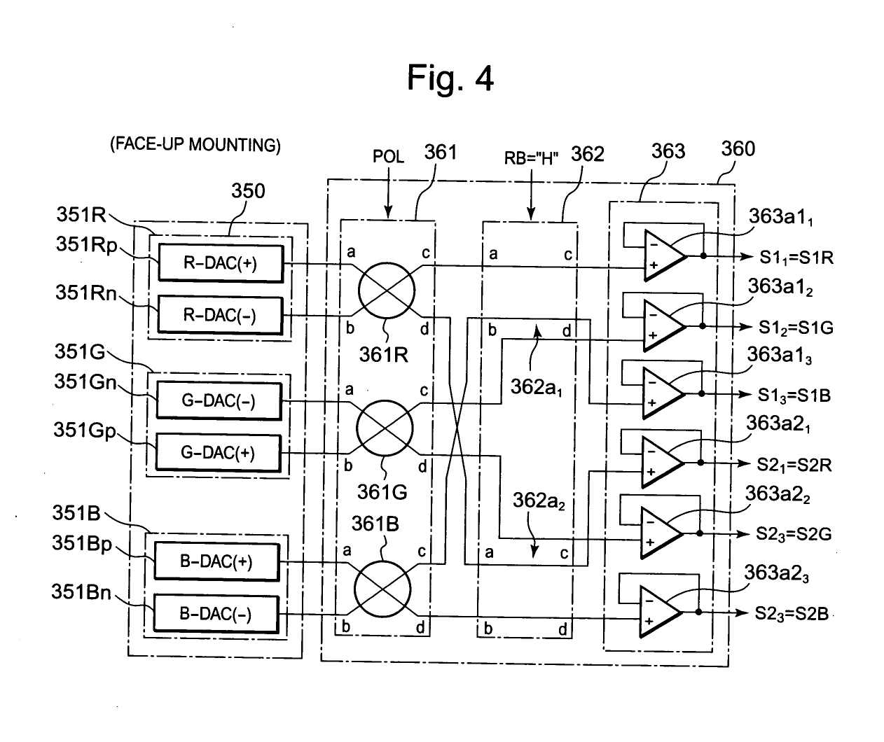

Descriptions will be provided for operations of the output circuit 360 with reference to FIGS. 4 to 9. It should be noted that the outputs of the D/A converter 351G are always connected respectively to the noninverting terminals of the AMPs 363a1₂ and 363a2₂ via the switching switch 361G, and that the output terminals S1₂ of the AMP 363a1₂ always functions as the output terminal S1G from which the drive signal GV1 representing the G color is outputted, whereas the output terminal. S2₂ of the AMP 363a2₂ always function as the output terminals S2G from which the drive signal GV2 representing the G color is outputted.

(See FIG. 4 for the Case where the Data Drive Circuits 300 are Mounted Face Up)

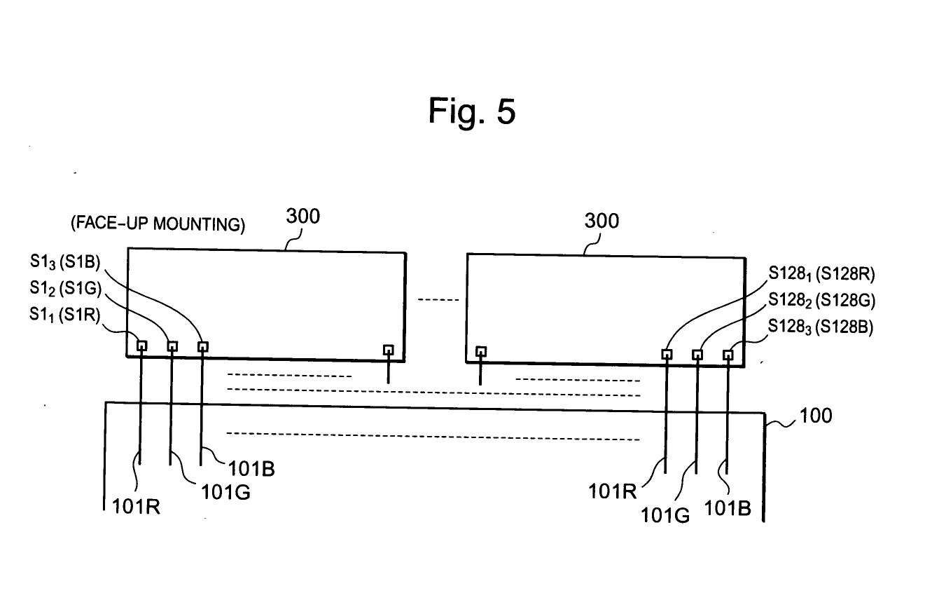

The reverse switching signal RB is set at the “H” level. In each of the switching switches 362a₁ and 362a₂, the input terminal a is connected to the output terminal c, whereas the input terminal b is connected to the output terminal d. Thereby, the outputs of the D/A converter 351R are connected to the noninverting input terminals respectively of the AMPs 363a1₁ and 363a2₁ via the switching switch 361R. Thus, the output terminal S1₁ functions as the output terminal S1R from which the drive signal RV1 representing the R color is outputted, whereas the output terminal S2₁ functions as the output terminal S2R from which the drive signal RV2 representing the R color is outputted. In addition, the outputs the D/A converter 351B are connected to the noninverting input terminals respectively of the AMPs 363a1₃ and 363a2₃ via the switching switch 361B. Thus, the output terminal S1₃ functions as the output terminal S1B from which the drive signal BV1 representing the B color is outputted, whereas the output terminal S2₃ functions as the output terminal S2B from which the drive signal BV2 representing the B color is outputted. As a result, when the data drive circuit 300 is mounted face up on thereon, the output terminals S1₁ (SIR) to S128₁ (S128R) from which the respective drive signals RV1 to RV128 representing the R color are outputted can be connected to the R data lines 101R, and concurrently the output terminals S1₃ (S1B) to S128₃ (S128B) from which the respective drive signals BV1 to BV128 representing the B color are outputted can be connected to the B data lines 101B, as shown in FIG. 5. In this manner, in the case where the data drive circuit 300 is used for the face-up mounting, the sequence in which the output terminals of the data drive circuit 300 are arranged is designed to be the same as the sequence in which the data lines 101R, 101G or 101B of the display panel 100, which correspond to the output terminals, are arranged.

Description will be provided for how the polarity switching circuit 361 operates when the reverse switching signal RB is at the “H” level.

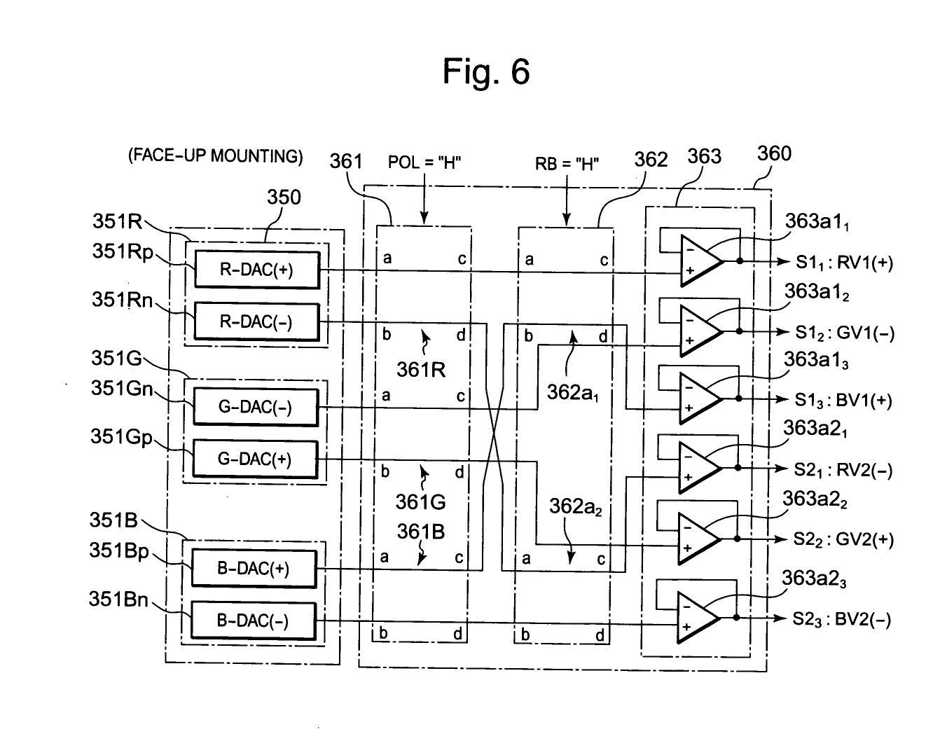

(See FIG. 6 for the Operations to be Carried Out when the Pol is at the “H” Level.)

In each of the switching switches 361R, 361G and 361B, the input terminal a is connected to the output terminals c, whereas the input terminal b is connected to the output terminal d. By this, the output of the D/A converter 351Rp is inputted to the AMP 363a1₁, and thus the positive drive signal RV1 (+) is outputted from the output terminal S1₁ thereof. The output of the D/A converter 351Gn is inputted to the AMP 363a1₂, and thus the negative drive signal GV1 (−) is outputted from the output terminal S1₂ thereof. Similarly, the positive drive signals BV1 (+) and GV2 (+) are outputted respectively from the output terminals S1₃ and S2₂, whereas the negative drive signals RV2 (−) and BV2 (−) are outputted respectively from the output terminals S2₁ and S2₃.

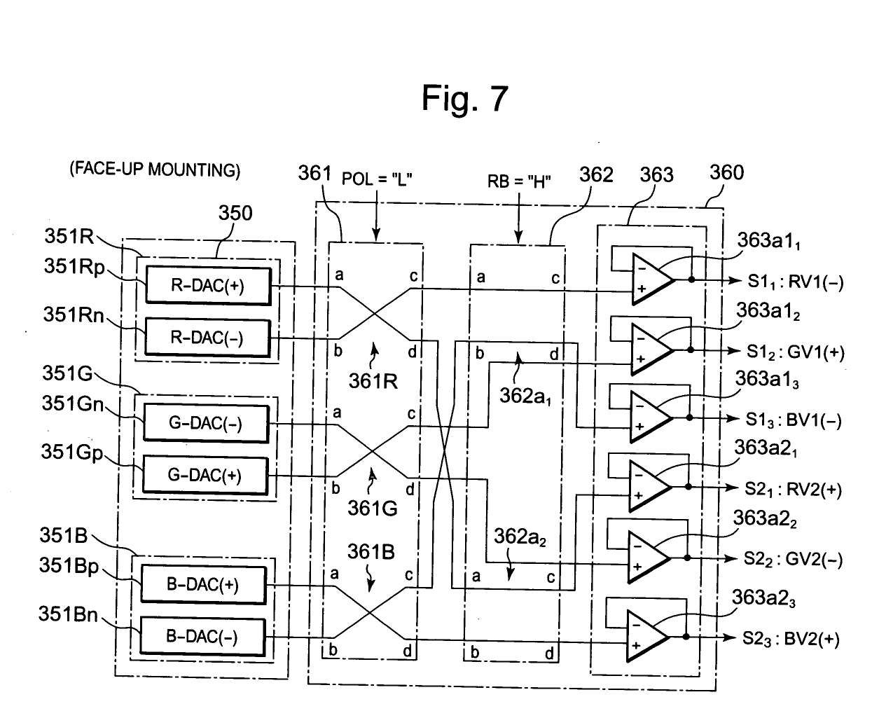

(See FIG. 7 for the Operations to be Carried Out when the Pol is at the “L” Level.)

In each of the switching switches 361R, 361G and 361B, the input terminal a is connected to the output terminals d, whereas the input terminal b is connected to the output terminal c. By this, the output of the D/A converter 351Rn is inputted to the AMP 363a1₁, and thus the negative drive signal RV1 (−) is outputted from the output terminal S1₁ thereof. The output of the D/A converter 351Gp is inputted to the AMP 363a1₂, and thus the positive drive signal GV1 (+) is outputted from the output terminal S1₂ thereof. Similarly, the negative drive signals BV1 (−) and GV2 (−) are outputted respectively from the output terminals S1₃ and S2₂, whereas the positive drive signals RV2 (+) and BV2 (+) are outputted respectively from the output terminals S2₁ and S2₃.

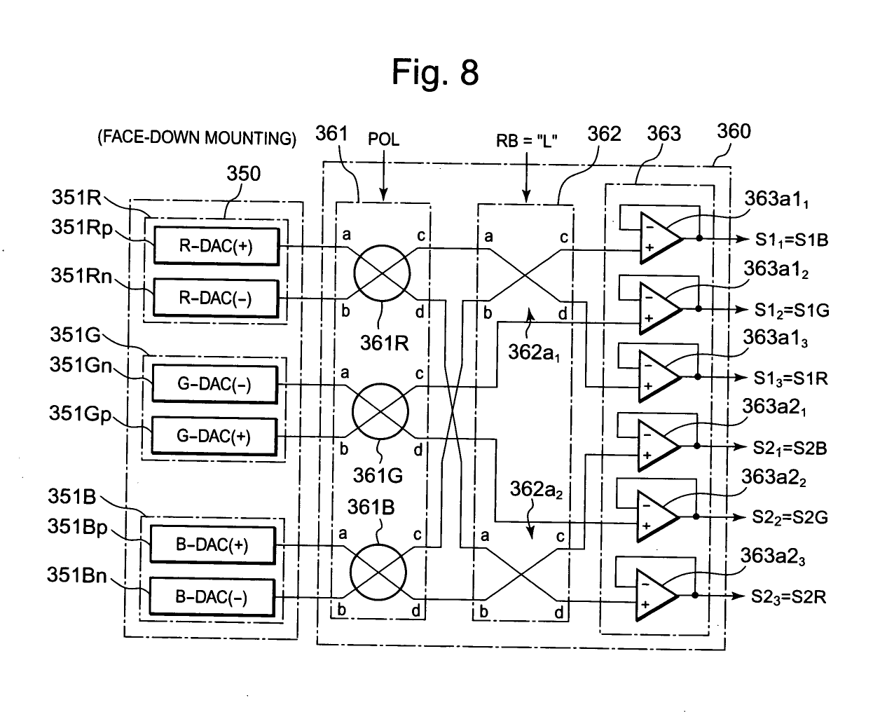

(See FIG. 8 for the Case where the Data Drive Circuits 300 are Mounted Face Down)

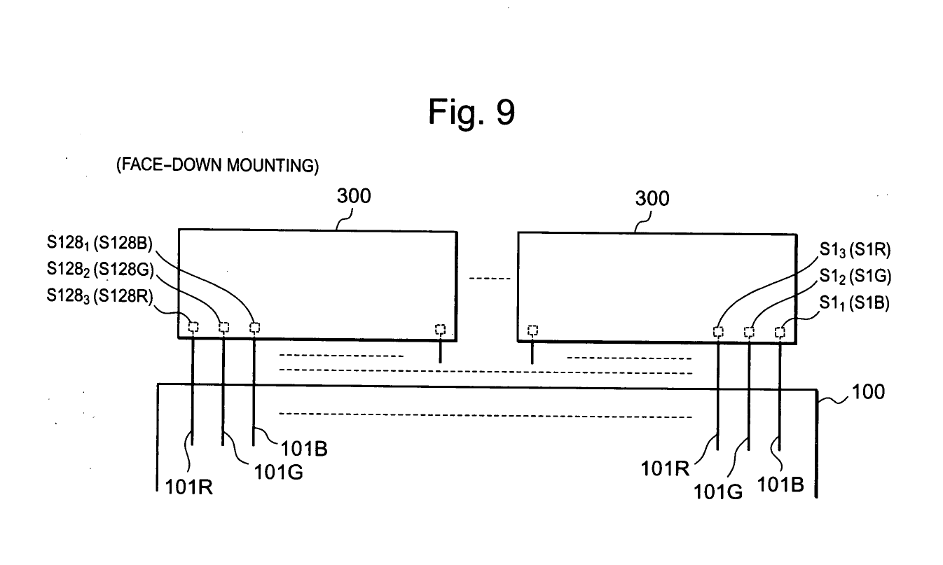

The reverse switching signal RB is set at the “L” level. In each of the switching switches 362a₁ and 362a₂, the input terminal a is connected to the output terminal d, whereas the input terminal b is connected to the output terminal c. Thereby, the outputs of the D/A converter 351B are connected to the noninverting input terminals respectively of the AMPs 363a1₁ and 363a2₁ via the switching switch 361B. Thus, the output terminal S1₁ functions as the output terminal S1B from which the drive signal BV1 representing the B color is outputted, whereas the output terminal S2₁ functions as the output terminal S2B from which the drive signal BV2 representing the B color is outputted. In addition, the outputs the D/A converter 351R are connected to the noninverting input terminals respectively of the AMPs 363a1₃ and 363a2₃ via the switching switch 361R. Thus, the output terminal S1₃ functions as the output terminal S1R from which the drive signal RV1 representing the R color is outputted, whereas the output terminal S2₃ functions as the output terminal S2R from which the drive signal RV2 representing the R color is outputted. As a result, when the data drive circuit 300 is mounted face down on thereon, the output terminals S1₃ (S1R) to S128₃ (S128R) from which the respective drive signals RV1 to RV128 representing the R color are outputted can be connected to the R data lines 101R, and concurrently the output terminals S1₁ (S1B) to S128₁ (S128B) from which the respective drive signals BV1 to BV128 representing the B color are outputted can be connected to the B data lines 101B, as shown in FIG. 9. In this manner, the sequence in which the output terminals of the data drive circuit 300 are arranged is designed to be the same as the sequence in which the data lines 101R, 101G or 101B of the display panel 100, which correspond to the output terminals, are arranged. It should be noted that the operations which the polarity switching circuit 361 carries out when the reverse switching signal RB is at the “L” level are similar to those which the polarity switching circuit 361 carries out when the reverse switching signal RB is at the “H” level. For this reason, the illustration and descriptions for the operations will be omitted.

As described above, in the case where the data drive circuit 300 is used for the face-up mounting, the reverse switching circuit 362 is controlled by the reverse switching signal RB which is at the “H” level. Thereby, the output terminals S1₁ to S128₁ are caused to function respectively as the output terminals S1R to S128R each from which to output the corresponding drive signal representing the R color, whereas the output terminals S1₃ to S128₃ are caused to function respectively as the output terminals S1B to S128B each from which to output the corresponding drive signal representing the B color. In the case where the data drive circuit 300 is used for the face-down mounting, the reverse switching circuit 362 is controlled by the reverse switching signal RB which is at the “L” level. Thereby, the output terminals S1₁ to S128₁ are caused to function respectively as the output terminals S1B to S128B each from which to output the corresponding drive signal representing the B color, whereas the output terminals S1₃ to S128₃ are caused to function respectively as the output terminals S1R to S128R each from which to output the corresponding drive signal representing the R color. These operations make it possible for IC chips of a single type to be dually used as data drive circuits 300 to be mounted face-up and to be mounted face-down.

While the invention has been described in terms of several exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

What is claimed is:

1. A semiconductor integrated circuit device, comprising:
a dual-use terminal; and
a switch to switch functions of the dual-use terminal in order that the dual-use terminal functions as one of a terminal for face-up mounting and a terminal for face-down mounting of the semiconductor integrated circuit device on a substrate.

2. The semiconductor integrated circuit device as claimed in claim 1, wherein
the semiconductor integrated circuit device comprises a data drive circuit for driving a display panel, and
the dual-use terminal comprises an output terminal for outputting a drive signal to the display panel.

3. The semiconductor integrated circuit device as claimed in claim 2, wherein
the dual-use terminal is configured as first, second and third output terminals arranged in a repeated sequence, the first output terminal being that from which a drive signal with a first characteristic is outputted, the second output terminal being that from which a drive signal with a second characteristic is outputted, and the third output terminal being that from which a drive signal with a third characteristic is outputted, and
the arrangement is switched between the first output terminal and the third output terminal by the switch.

4. The semiconductor integrated circuit device as claimed in claim 3, wherein
the first to third characteristics comprise γ-curve characteristics, and
the γ-curve characteristics are different from one to another.

5. The semiconductor integrated circuit device as claimed in claim 4,
further comprising a digital-to-analog (D/A) converter that converts a digital data signal to the drive signal, said D/A converter including:
a first D/A converter that outputs the drive signal with the first γ-curve characteristic;
a second D/A converter that outputs the drive signal with the second γ-curve characteristic; and
a third D/A converter that outputs the drive signal with the third γ-curve characteristic.

6. The semiconductor integrated circuit device as claimed in claim 4, wherein the first to third γ-curve characteristics correspond to red, green and blue dot-pixels on a one-to-one basis.

7. A display driver, comprising:
a plurality of groups each containing first and second output terminals arranged repeatedly in that order;
a first input terminal that receives a first color data;
a second input terminal that receives a second color data; and
a reverse circuit that conveys said first and second color data into said first and second output terminals, respectively, in a first mode, and conveys said second and first color data into said first and second output terminals, respectively, in a second mode.

8. The driver as claimed in claim 7, wherein:
a plurality of third output terminals, each of which is arranged between the respective first output terminal and the respective second output terminal;
a third input terminal receives a third color data; and
said reverse circuit conveys said third color data into said third output terminal in said first and second mode.

9. The driver as claimed in claim 8, wherein said first color is red, said second color is blue and said third color is green.

10. The driver as claimed in claim 9, further comprising:
a first D/A that converter that receives said red data inputted to said first input terminal;
a second D/A converter that receives said blue data inputted to said first input terminal;
a third D/A converter that receives said green data inputted to said third input terminal.

11. The driver as claimed in claim 10,
wherein said first D/A converter includes a positive polarity DA converter and a negative polarity D/A converter.

12. The driver as claimed in claim 11,
wherein said reverse circuit connects said negative polarity D/A converter of said first D/A converter to the first terminal of the first group, and connects said positive polarity D/A converter of said first D/A converter to the first terminal of the second group in the first mode, and
wherein said reverse circuit connects said negative polarity D/A converter of said first D/A converter to the second terminal of the first group, and connects said positive polarity D/A converter of said first D/A converter to the second terminal of the second group in the second mode,

13. The driver as claimed in claim 10, further comprising:
a polarity switching circuit provided between said D/A converters and said reverse circuit.

14. A display driver, comprising:
a positive polarity first color signal generator that outputs a first signal;
a negative polarity first color signal generator that outputs a second signal;
a positive polarity second color signal generator that outputs a third signal;
a negative polarity second color signal generator that outputs a fourth signal;
a first polarity switching circuit that conveys said first signal to a first node and said second signal to a second node in a first polarity, and conveys said first signal to said second node and said second signal to said first node in a second polarity;
a second polarity switching circuit that conveys said third signal to third node and said fourth signal to a fourth node in said first polarity, and conveys said third signal to said fourth node and said fourth signal to said third node in said second polarity;
first to fourth output circuits;
a first reverse circuit that connects said first node with said first output circuit and said third node with said second output circuit in a first mode, and connects said first node with said second output circuit and said third node with said first output circuit in a second mode; and
a second reverse circuit that connects said second node with said third output circuit and said fourth node with said fourth output circuit in said first mode, and that connects said second node with said fourth output circuit and said fourth node with said third output circuit in a second mode.

15. The display driver as claimed in claim 14, wherein the first color is a red color and the second color is a blue color.
